(19) United States
(12) Patent Application Publication
(10) Pub. No.: US 2024/0219545 A1
(43) Pub. Date: Jul. 4, 2024

(54) MOTORIZED MOUNT ASSEMBLY FOR TRANSDUCER

(71) Applicant: Livescanner LLC, Hillsboro, MO (US)

(72) Inventor: Ronnie K. Baker, Hillsboro, MO (US)

(21) Appl. No.: 18/404,704

(22) Filed: Jan. 4, 2024

Related U.S. Application Data
(60) Provisional application No. 63/437,089, filed on Jan. 4, 2023.

(51) Int. Cl. G01S 7/521; G01S 15/96

(52) U.S. Cl. CPC G01S 7/521; G01S 15/96

(57) ABSTRACT

A mount assembly for connecting a sonar transducer to a boat. The assembly includes a bracket, a housing, and a stepper motor having an output that rotates in response to a signal. A control module connected to the motor sends the input signal to the motor. The assembly includes a shaft having an upper end, a lower end, and a central axis. The upper end is connected to the output for rotation when the control module sends the signal to the motor. The shaft is adapted to mount a sonar transducer adjacent to the lower end. The assembly comprises a connector operationally connecting the shaft to the output of the motor, so the shaft rotates as the output rotates. The connector is configured to allow the output of the motor to rotate independently from the shaft when an obstruction prevents the shaft from turning.

### CROSS-REFERENCE TO RELATED APPLICATION

The present application claims priority to co-pending U.S. Provisional Patent Application Ser. No. 63/437,089, which was filed on Jan. 4, 2023, and entitled, “MOTORIZED MOUNT FOR TRANSDUCER”, which is hereby incorporated by reference in its entirety.

### BACKGROUND

This disclosure is directed to a motorized mount, and more particularly to a motorized, selectively rotatable mount assembly adapted to receive a sonar transducer for locating aquatic life.

Anglers use sonar technology to detect underwater objects. The technology enables anglers to determine water depth and bottom topography, and to locate underwater features that present promising habitats for fish, as well as to locate individual fish. Sonar equipment used by anglers generally includes a processing unit (or processor) and a display unit (or display) positioned on a boat and a sonar transducer positioned underwater and connected to the processing unit by electrical leads bundled in a cable. The processor signals the transducer to emit sound waves, which travel through the water and reflects off objects. The transducer converts returning sound waves to electrical signals that the processor analyzes using an estimated speed of sound in water to produce a processed signal that is transmitted to the display. The display includes a screen (e.g., an LED or LCD screen) for showing an image representing shapes and locations of the objects off of which the sound waves reflect.

On smaller boats typically used by anglers, the transducer is mounted on a lower end of a staff or probe attached to the boat and extending into the water. The probe is attached either directly to a hull (e.g., a transom, a gunnel, a foredeck, or other structure) or to a motor mounted on the boat. Because transducers are directional, knowing the transducer orientation is important to determining the locations of the underwater objects relative to the boat. When searching for fish, having an ability to rotate the transducer to point in selected directions relative to the boat is desirable to locate objects at locations around the boat. Usually, the probe extends vertically from the boat and is rotatable about its longitudinal axis to vary transducer direction. Frequently, the probe is connected to a stepper motor that is controlled by the angler. A control unit (or controller) positioned onboard the boat allows the angler to selectively energize the stepper motor to rotate the probe, so the transducer faces a desired direction. The control unit frequently includes a right pedal that the angler presses to pivot the probe clockwise (as viewed from above) and a left pedal that the angler presses to pivot the probe counterclockwise. The controller usually includes a power on/off selector for selectively energizing the stepper motor and an indicator (e.g., an LED) to indicate whether the selector is energized. Further, some controllers include a radio receiver for receiving a signal from a wireless control fob configured to transmit signals when the angler pushes buttons on the fob. Although these controllers allow the angler to selectively change the sonar transducer orientation, prior sonar systems require the angler's attention to control the probe thereby diverting attention from catching fish.

Contact between a sonar transducer and a submerged object can damage the transducer, rendering it unusable until replaced. In spite of the cost of replacing a transducer, current sonar systems do not allow the probe to be quickly adjusted to change transducer depth nor do current systems protect sonar transducers from being damaged by submerged objects. In view of the drawbacks inherent in current sonar systems, it is apparent there is a need for an improved system that overcomes the disadvantages of current systems.

### SUMMARY

In one aspect, the present disclosure includes a mount assembly for connecting a sonar transducer to a boat for locating aquatic life in water adjacent to the boat. The mount assembly comprises a bracket capable of being connected to a boat and a housing having a hollow interior mounted on the bracket. A stepper motor positioned inside the hollow interior of the housing has an output that rotates relative to the housing in response to an input signal. A control module operatively connected to the stepper motor is adapted to send the input signal to the stepper motor to selectively rotate the output. The mount assembly also includes an elongated shaft having an upper end, a lower end, and an elongated central axis extending between the upper end and the lower end. The upper end is operationally connected to the output of the stepper motor for selective rotation about the central axis relative to the housing when the control module sends the input signal to the stepper motor. Further, the shaft is adapted to mount a sonar transducer adjacent to the lower end for positioning the sonar transducer in water. The mount assembly also comprises a connector operationally connecting the elongated shaft to the output of the stepper motor, so the elongated shaft rotates about the central axis relative to the housing as the output of the stepper motor rotates when the control module sends the input signal to the stepper motor. The connector is configured to allow the output of the stepper motor to rotate independently from the elongated shaft when an obstruction prevents the elongated shaft from turning about the central axis.

In another aspect, the present disclosure includes a mount assembly for connecting a sonar transducer to a boat for locating aquatic life in water adjacent to the boat. The mount assembly comprises a bracket capable of being connected to a boat including a sleeve and a housing having a hollow interior mounted on the bracket. A stepper motor positioned inside the hollow interior of the housing has an output that rotates relative to the housing in response to an input signal. A control module operatively connected to the stepper motor is adapted to send the input signal to the stepper motor to selectively rotate the output. An elongated shaft extending through the sleeve mounts the housing on the bracket. The shaft has an upper end, a lower end, and an elongated central axis extending between the upper end and the lower end. The upper end is operationally connected to the output of the stepper motor for selective rotation about the central axis relative to the housing when the control module sends the input signal to the stepper motor. The shaft is adapted to mount a sonar transducer adjacent to the lower end for positioning the sonar transducer in water. The mount assembly comprises an elastically deformable ferrule having an opening corresponding to the shaft and a fastener adapted to be selectively screwed to the sleeve to compress the ferrule to hold the shaft in the sleeve to prevent the shaft from moving longitudinally relative to the central axis in the sleeve. The fastener is adapted to be selectively unscrewed from the sleeve to allow the ferrule to expand to release the shaft permitting the shaft to be moved longitudinally relative to the central axis of the sleeve.

In a further aspect, the present disclosure includes a mount assembly for connecting a sonar transducer to a boat for locating aquatic life in water adjacent to the boat. The mount assembly comprises a bracket including a base adapted to connect to the boat, an arm pivotally connected to the base, and a clamp capable of preventing the arm from pivoting relative to the base. A housing having a hollow interior is mounted on the arm of the bracket so that the housing moves relative to the base as the arm pivots with respect to the base. A stepper motor positioned inside the hollow interior of the housing has an output that rotates relative to the housing in response to an input signal. A control module operatively connected to the stepper motor is adapted to send the input signal to the stepper motor to selectively rotate the output. An elongated shaft extends through the sleeve to mount the housing on the bracket. The shaft has an upper end, a lower end, and an elongated central axis extending between the upper end and the lower end. The upper end is operationally connected to the output of the stepper motor for selective rotation about the central axis relative to the housing when the control module sends the input signal to the stepper motor. The shaft is adapted to mount a sonar transducer adjacent to the lower end for positioning the sonar transducer in water. The mount assembly also comprises a programmable control spaced from the housing and operatively connected to the control module in the hollow interior of the housing to signal the control module to rotate the output of the stepper motor. The programmable control is adapted to receive user input to signal the control module to rotate the output of the stepper motor to rotate the shaft clockwise as viewed from above relative to the bracket and to receive user input to signal the control module to rotate the output of the stepper motor to rotate the shaft counterclockwise as viewed from above relative to the bracket.

Other aspects of the present disclosure will be apparent in view of the following description and claims.

### BRIEF DESCRIPTION OF DRAWINGS

This description includes disclosure of the present system by way of non-limiting examples illustrated in the accompanying drawings.

FIG. 1 is a fragmentary perspective of a portion of a boat having a trolling motor and a motorized rotating sonar transducer mount assembly;

FIG. 2 is a fragmentary perspective of a motorized rotating sonar transducer mount assembly;

FIG. 3 is a fragmentary separated perspective of the motorized rotating sonar transducer mount assembly;

FIG. 4 is a side elevation of the motorized rotating sonar transducer mount assembly;

FIG. 5 is a vertical cross section of the motorized rotating sonar transducer mount assembly;

FIG. 6 is a perspective of a bracket assembly for attaching the transducer mount assembly to the motor;

FIG. 7 is a perspective of a foot control for the motorized rotating sonar transducer mount assembly;

FIG. 8 is a separated perspective of the foot control for the motorized rotating sonar transducer mount assembly;

FIG. 9 is an alternative separated perspective of the foot control for the motorized rotating sonar transducer mount assembly.

Corresponding reference characters indicate corresponding parts throughout the drawings.

### DETAILED DESCRIPTION

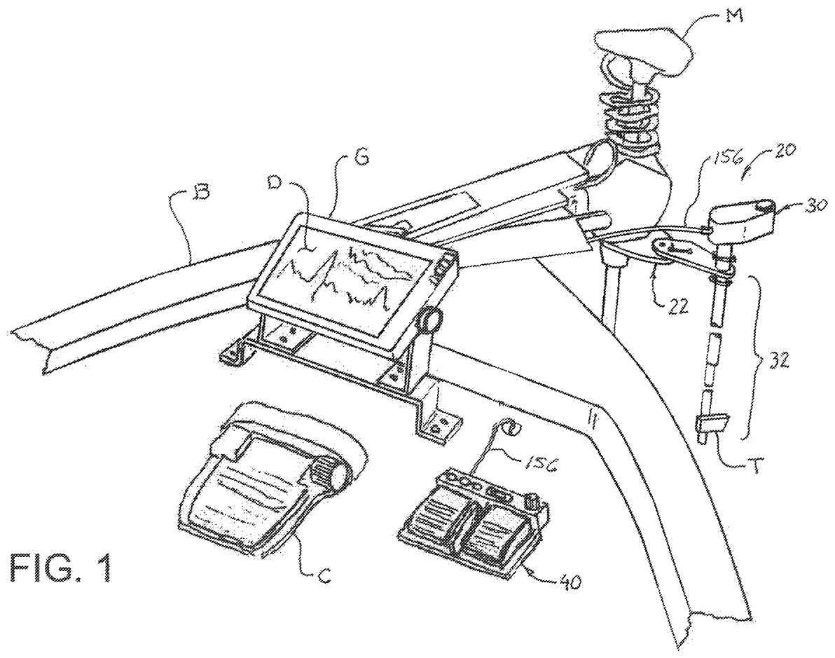

FIG. 1 illustrates a bow portion of a boat B (broadly, a watercraft) that is driven by a conventional trolling motor M. A conventional motor control C is positioned on the boat B to allow an angler to control the trolling motor M. A conventional GPS unit G having an LCD display D is mounted on the boat B to aid the angler with navigation. As further shown in FIG. 1, a motorized rotating sonar transducer mount assembly is designated in its entirety by the reference number 20. Although the transducer mount assembly may be connected directly to the boat B, the illustrated mount assembly 20 is attached to the motor M by a bracket assembly, generally designated by 22. The transducer mount assembly 20 generally comprises a head, generally designated by 30, and a shaft assembly, generally designated by 32. A foot control, generally designated by 40, positioned on the boat B is operatively connected to the transducer mount assembly 20 for controlling operation of the mount assembly. A conventional sonar transducer T is mounted on the shaft assembly 32 for transmitting and receiving sound waves through water below the boat B.

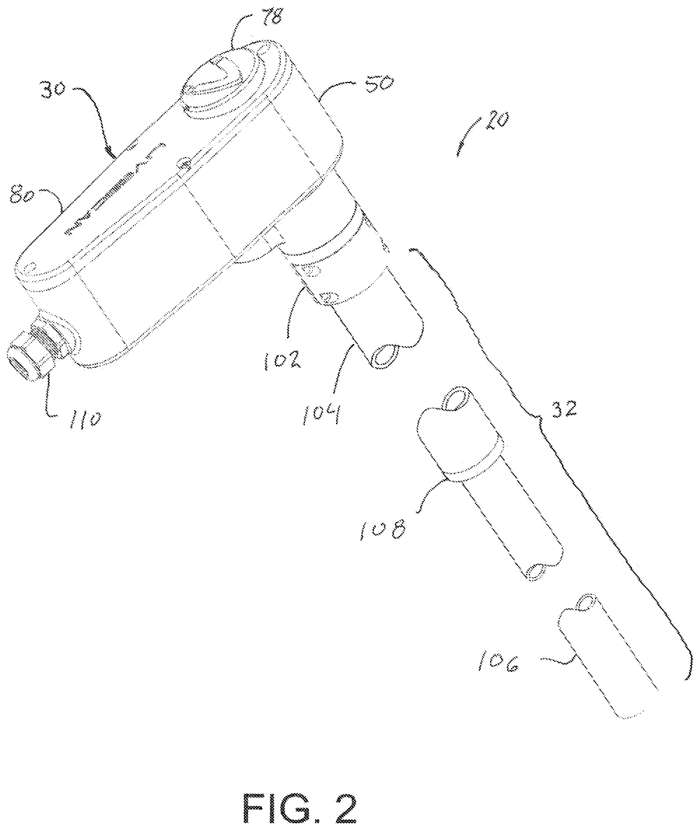

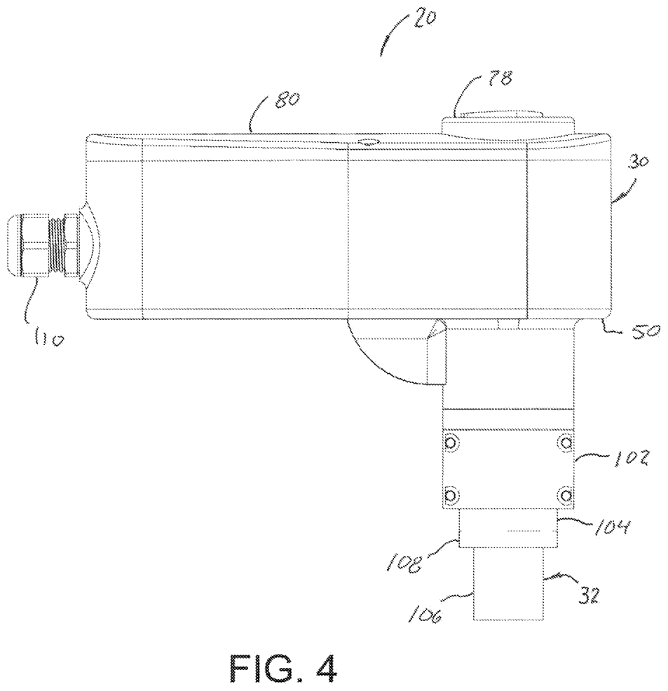

As illustrated in FIGS. 2-5, the head 30 includes a housing 50 having a hollow interior 52 that is sized and shaped for receiving a motor assembly, generally designated by 54, and an electronic control module 56 adapted to signal the motor assembly to rotate a portion of the shaft assembly 32. The motor assembly 54 includes a conventional stepper motor 58 and a transmission 60 operationally coupling to the stepper motor. The transmission 60 has an output shaft 62 that rotates as the stepper motor turns. The transmission 60 is geared to reduce the angular rotation such that the output shaft 62 rotates 90° as the output of the stepper motor makes four-and-one-quarter rotations.

The output shaft 62 extends vertically through the transmission 60. An upper end of the shaft 62 is connected to an indicator 64 by a sensor assembly, generally designated by 66, configured to signal the electronic control module 56 when the output shaft 62 is oriented in a “home” position. This position is stored in the control module 56 so the angular orientation of the shaft assembly 32 may be computed from the number of steps the motor has rotated away from the home position. Although the sensor assembly may have other configurations and components, the illustrated sensor assembly 66 includes a base plate 68 that is fastened to the transmission 60. A shim 70, a guard 72, and a position sensor 74 are fastened to the plate 68, and a coupling 76 engages the upper end of the transmission output shaft 62, so the coupling turns with the output shaft. An indicator 78 positioned above a housing cover 80 extends through an opening in the cover and engages the coupling 76 so the indicator is visible when the cover is fastened to the housing 50 and the indicator turns with the transmission output shaft 62. In some examples, the indicator 78 is formed from translucent material and illuminated by a light emitting diode (“LED”, not shown) positioned in the interior cavity 52 of the housing 50 so the orientations of the shaft assembly 32 and transducer T are visible in low light conditions. In some examples, a translucent trademark is formed on the cover 80 so the LED in the housing 50 illuminates the trademark. A connector 90 is fastened to a lower end of the shaft 62 by a set screw 92. An opening extending through the connector below the set screw 92 receives a pair of hardened steel balls 94 separated by a compression spring 96. Although the balls and spring may be held in the connector using other means, the illustrated connector 90 is swaged (i.e., deformed) to retain the balls 94 and spring 96. The spring 96 biases the balls 94 outward so they protrude from each end of the connector opening. The balls 94 engage a pair of opposing slots 98 formed at an upper end of the shaft assembly 32. As will be appreciated the balls 94 form a detent that engages the slots (broadly, openings) in the shaft assembly 32 to allow the motor output to rotate independently of the shaft.

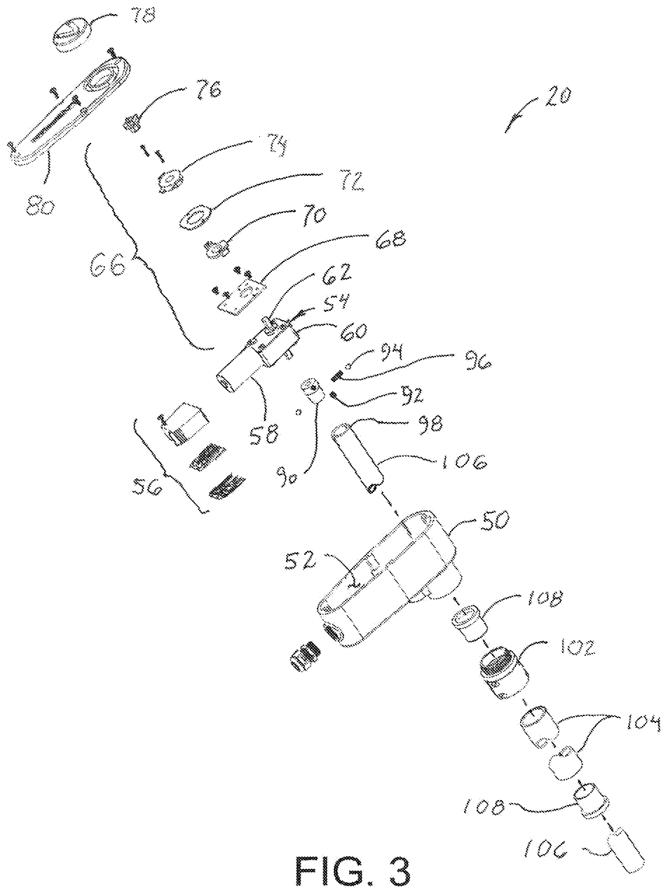

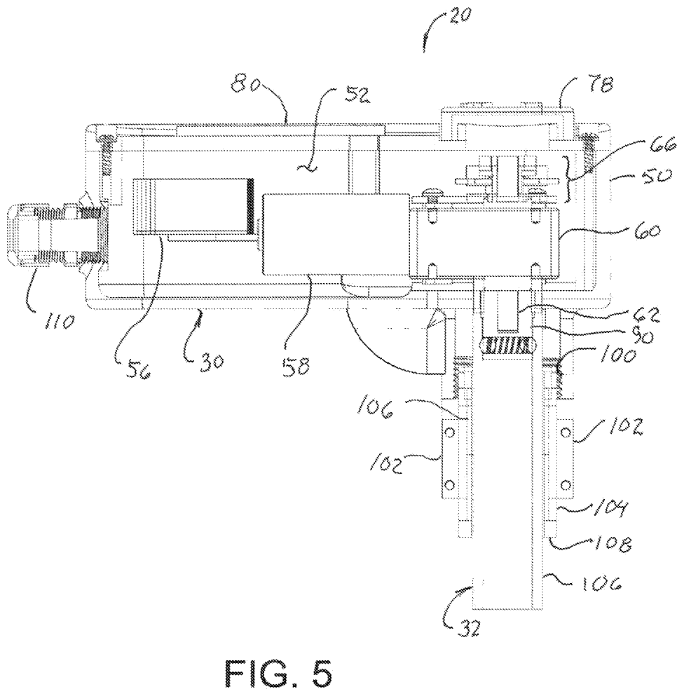

As illustrated in FIG. 5, the housing 50 has a threaded opening 100 below the connector 90 for receiving a clamp 102 that fastens the head 30 to the shaft assembly 32. As shown in FIG. 3, the shaft assembly 32 comprises an outer shaft 104 and an inner shaft 106 separated by bushings 108 mounted at an upper end and a lower end of the outer shaft. The clamp 100 holds the outer shaft 104 in a fixed position relative to the housing 50, and the bushings 108 permit the inner shaft 106 to rotate freely in the outer shaft. As will be appreciated, the previously mentioned slots 98 are formed at an upper end of the inner shaft 106. Thus, under normal conditions when the motor 58 drives the transmission output shaft 62 and connector 90, the spring loaded balls 94 engage the slots 98 so the inner shaft 106 turns in the bushings 108. As the inner shaft 106 rotates, a transducer T (not shown) mounted on a lower end of the inner shaft turns with the shaft. When, however, the transducer T encounters a submerged obstruction such as weeds that resist rotation of the transducer and inner shaft 104, the spring biased balls 94 retract into the connector 90 and disengage the slots 98. When the connector 90 disengages the inner shaft 106, the connector rotates inside the inner shaft as the motor 60 and transmission output shaft 62 turn. As will be appreciated, when the submerged object prevents the transducer T and inner shaft 106 from turning, the connector 90 disengages the inner shaft 106 so the motor 58 and transmission 60 are not damaged and the transducer is not forced against the object. As further shown in FIGS. 2-5, a fitting 110 is fastened to the housing 50 for receiving a cable (not shown) to provide electrical power and signals to the control module 56 and motor 58.

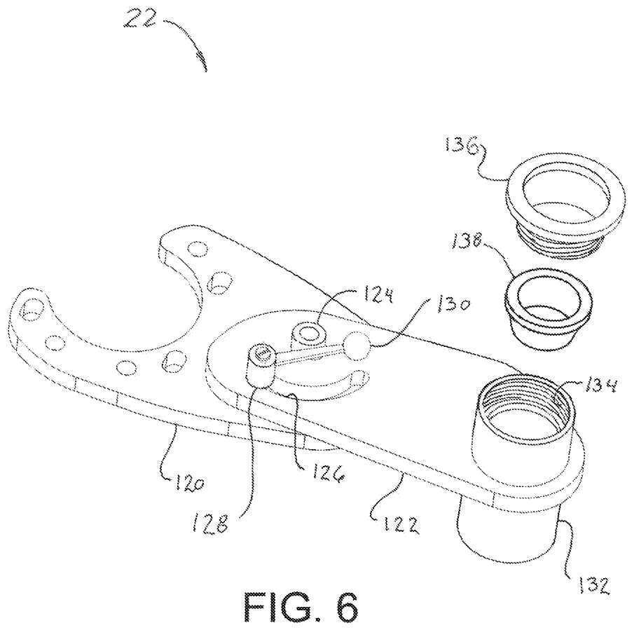

FIG. 6 shows the bracket assembly 22 for mounting the transducer mount assembly 20 to a trolling motor M. The assembly 22 includes a base 120 having a hole pattern matching that of the motor and an arm or extension 122 pivotally connected to the base by a pin assembly 124. An arcuate slot 126 is provided in the arm 122 for receiving a threaded fastener assembly 128 extending upward from the base 120 to selectively clamp the arm 122 in a desired position relative to the base. In the illustrated bracket assembly 22, the threaded fastener assembly 128 includes a lever 130 to enhance the angler's ability to clamp and unclamp the arm 122. The arm 122 includes a sleeve 132 opposite the pin assembly 124 for receiving the outer shaft 104 of the shaft assembly 32. Screw threads 134 are provided inside each end of the sleeve 132 for engaging a threaded nut 136. Although the bracket assembly 22 has two identical opposing nuts, only one nut 136 (i.e., an upper nut) is shown in FIG. 6. The opposing lower nut is threaded into the lower end of the sleeve 132. An elastomeric ferrule 138 is captured between the sleeve 132 and each nut 136. When the nut 136 is tightened, the ferrule 138 is axially compressed so the ferrule bulges inwardly and tightly grips the outer shaft 104 of the shaft assembly 32 generally as shown in FIG. 1. This arrangement allows an angler to selectively raise and lower the transducer mount assembly 20 by loosening the nuts 136, sliding the inner shaft 106 to a desired height, and tightening the nuts to firmly hold the inner shaft and transducer T at the newly selected height. Thus, the mount assembly 20 may be raised when fishing in shallow waters or over weed beds or when loading the boat B on a trailer to prevent the transducer from being damaged. And the mount assembly 20 may be lowered in deeper waters to provide optimal transducer T operation.

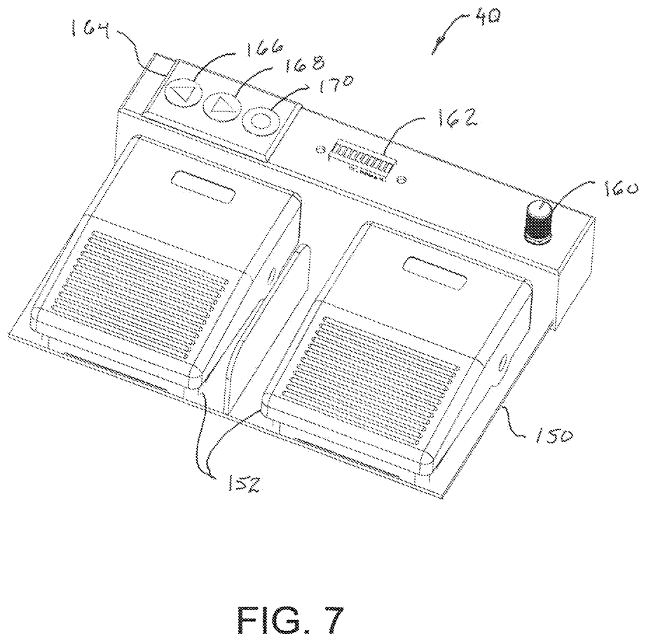

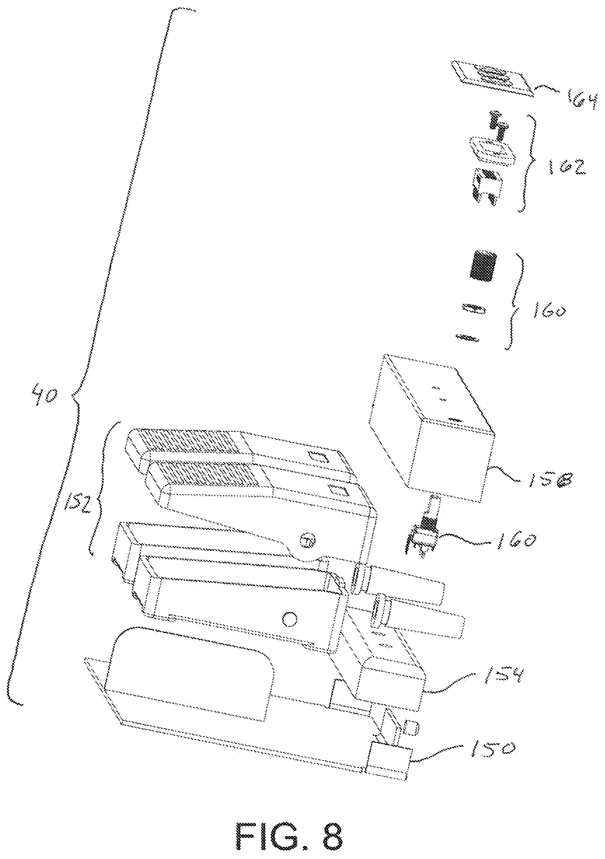

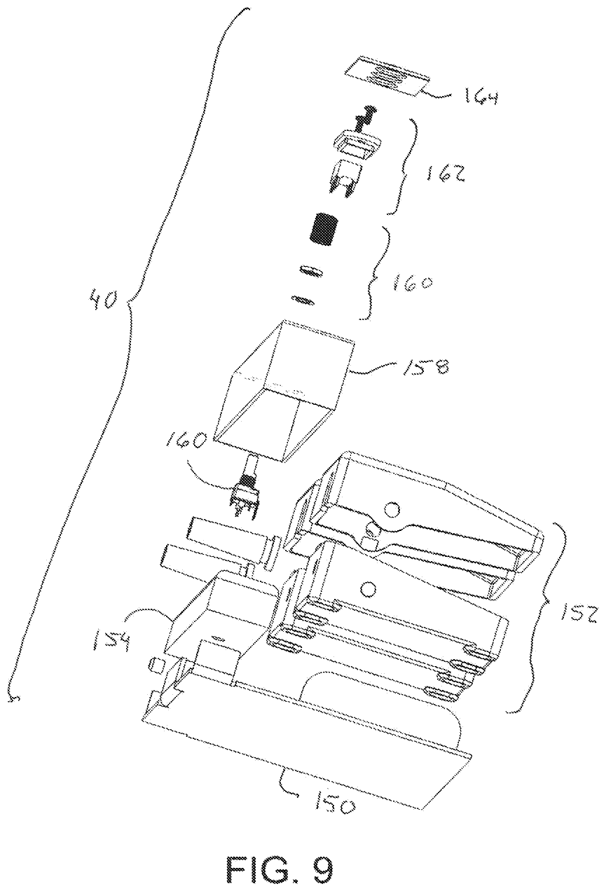

FIGS. 7-9 show a foot control 40 that is operatively connected to the mount assembly 20 for controlling inner shaft 106 and transducer T movement. The control 40 includes a base 150 on which two pedal assemblies 152 are mounted. As will be appreciated, in a normal mode of operation when a user presses the right pedal, so its front edge pivots downward, the control 40 sends a signal to the control module 56 to cause the mount inner shaft 106 of the mount assembly 20 to rotate clockwise (when viewed from above). Likewise, pressing the left pedal sends a signal to the control module 56 causing the inner shaft 106 to rotate counterclockwise. A foot control module 154 is mounted on the base 150 behind the pedal assemblies 154. The control module 154 communicates with the control module 56 positioned in the head 30 of the mount assembly 20 by way of a cable 156 (FIG. 1) connecting the foot control 40 to the mount assembly 20. A cover 158 covers the foot control module 154. In the illustrated example, a variable resistor 160 is mounted on the cover 158 for controlling the speed at which the inner shaft 106 rotates. An LED meter 162 mounted adjacent the resistor 160 provides a visual indication of the speed at which the inner shaft 106 is rotating. A conventional water-tight, membrane keypad 164 is mounted adjacent the meter 162 to allow an angler to select a desired preprogrammed inner shaft 106 and transducer T motion. For example, the illustrated keypad 164 includes three buttons—a left button 166, a right button 168 and a stop button 170. The angler pushes the left button 166 to send a signal to the control module 56 to reciprocatively rotate the inner shaft 106 through a first predetermined arc. Pushing the right button 168 sends a signal to reciprocatively rotate the inner shaft 106 through a second predetermined arc located clockwise from the first predetermined arc. The angler pushes the stop button 170 to stop inner shaft 106 and transducer T motion and return to the normal mode of operation in which the foot pedals are pressed to control motion.

The electronic control module 56 may be programmed to control the motor 58 to turn the inner shaft 96 and the transducer T in several ways. For example, the control module 56 may signal the motor 58 to rotate the transmission output shaft 62 clockwise when the angler presses the right foot pedal 152 and counterclockwise when the angler presses the left foot pedal. Further, the control module 56 may be programmed so the motor 58 reciprocatively rotates back and forth to drive the inner shaft 96 through a predetermined angle (e.g., 90°).

Because the control module 56 stores the “home” position of the output shaft 96 and calculates an angle of orientation of the inner shaft 96, the control module may be programmed to reciprocatively rotate the inner shaft through a particular arc. In one example, the control module 56 is programmed to reciprocate the inner shaft 96 so the transducer rotates through an arc extending from about 45° counterclockwise relative to a forward direction to about 45° clockwise relative to the forward direction. In another example, the control module 56 is programmed to reciprocate the inner shaft 96 through a selected quadrant (e.g., about 45° counterclockwise to about 45° clockwise relative to the forward direction, about 45° clockwise to about 135° clockwise relative to the forward direction, about 45° clockwise to about 45° counterclockwise relative to a rearward direction, or about 45° counterclockwise to about 135° counterclockwise relative to the forward direction). Although the example describes rotating through 90°, it is envisioned that the module 56 may be programmed to reciprocate the inner shaft 96 through arcs of any length including a full 360° rotation or more.

A handheld fob (not shown) may be used in addition to or in place of the foot control 40. As will be appreciated, the fob sends radio signals in response to an angler pressing buttons on the fob. The radio signals are received by a receiver positioned in the head 30 to signal the control module 56 to move the inner shaft 106 accordingly.

As various changes could be made to the constructions and methods described herein, it is intended that all matter contained in the above description or shown in the accompanying drawings shall be interpreted as illustrative and not in a limiting sense. The patentable scope of the disclosure is defined by the claims, and can include other constructions and methods that would occur to those skilled in the art. Such other constructions are intended to be within the scope of the claims if the structural elements of the constructions do not differ from the literal language of the claims, or if the constructions include equivalent structural elements having insubstantial differences from the literal languages of the claims.

To the extent that the specification, including the claims and accompanying drawing, discloses any additional subject matter that is not within the scope of the claims below, the disclosures are not dedicated to the public and the right to file one or more applications to claims such additional disclosures is reserved.

When introducing elements of the present invention or example(s) thereof, the articles “a”, “an”, “the”, and “said” are intended to mean that there are one or more of the elements. The terms “comprising”, “including”, and “having” are intended to be inclusive and mean that there may be additional elements other than the listed element.

1. A mount assembly for connecting a sonar transducer to a boat for locating aquatic life in water adjacent to the boat, said mount assembly comprising:
a bracket capable of being connected to a boat;
a housing having a hollow interior mounted on the bracket;
a stepper motor positioned inside the hollow interior of the housing, said stepper motor having an output that rotates relative to the housing in response to an input signal;
a control module operatively connected to the stepper motor, said control module being adapted to send the input signal to the stepper motor to selectively rotate the output;
an elongated shaft having an upper end, a lower end, and an elongated central axis extending between the upper end and the lower end, said upper end being operationally connected to the output of the stepper motor for selective rotation about the central axis relative to the housing when the control module sends the input signal to the stepper motor, said shaft being adapted to mount a sonar transducer adjacent to the lower end for positioning the sonar transducer in water; and
a connector operationally connecting the elongated shaft to the output of the stepper motor, so the elongated shaft rotates about the central axis relative to the housing as the output of the stepper motor rotates when the control module sends the input signal to the stepper motor, the connector being configured to allow the output of the stepper motor to rotate independently from the elongated shaft when an obstruction prevents the elongated shaft from turning about the central axis.

2. A mount assembly as set forth in claim 1, wherein:
the shaft includes an opening adjacent to the upper end; and
the connector includes a detent that engages the opening in the upper end of the shaft to rotate the shaft as the output of the stepper motor rotates, said detent disengaging the opening in the upper end of the shaft upon the shaft being obstructed from rotating to allow the output of the stepper motor to rotate independently from the shaft.

3. A mount assembly as set forth in claim 2, wherein:
the connector includes a body having a hole extending laterally relative to the central axis of the elongated shaft;
a ball positioned in the hole for movement between an engaging position in which the ball protrudes from the body and a disengaging position in which the ball is positioned entirely inside the hole in the body, said ball being biased toward the engaging position;
the opening in the upper end of the shaft includes a slot extending parallel to the central axis of the elongated shaft; and
the ball engages the slot in the shaft when in the engaging position and disengages the slot when in the disengaging position to allow the body to rotate independently of the shaft.

4. A mount assembly as set forth in claim 1, wherein the bracket includes a sleeve through which the shaft extends to mount the housing on the bracket.

5. A mount assembly as set forth in claim 4, further comprising:
an elastically deformable ferrule having an opening corresponding to the shaft; and
a fastener adapted to be selectively screwed to the sleeve to compress the ferrule to hold the shaft in the sleeve to prevent the shaft from moving longitudinally relative to the central axis in the sleeve, wherein the fastener is adapted to be selectively unscrewed from the sleeve to allow the ferrule to expand to release the shaft permitting the shaft to be moved longitudinally relative to the central axis of the sleeve.

6. A mount assembly as set forth in claim 5, wherein:
the sleeve extends between an upper end and a lower end opposite the upper end;
said ferrule is an upper ferrule;
said fastener is an upper fastener adapted to be selectively screwed to the upper end of the sleeve to compress the upper ferrule; and
the mount assembly further comprises:
a lower elastically deformable ferrule having an opening corresponding to the shaft; and
a lower fastener adapted to be selectively screwed to the lower end of the sleeve to compress the lower ferrule to hold the shaft in the sleeve; and
when the upper fastener and the lower fastener are screwed to the sleeve, the upper fastener compresses the upper ferrule, and the lower fastener compresses the lower ferrule to hold the shaft in the sleeve to prevent the shaft from moving in the sleeve; and
when the upper fastener and the lower fastener are unscrewed from the sleeve the upper fastener permits the upper ferrule to expand and the lower fastener permits the lower ferrule to expand to release the shaft permitting the shaft to be moved longitudinally relative to the central axis of the sleeve.

7. A mount assembly as set forth in claim 1, wherein the bracket includes:
a base adapted for connecting to the boat;
an arm pivotally connected to the base, said sleeve extending from the arm so that the sleeve moves relative to the base as the arm pivots with respect to the base; and
a clamp capable of preventing the arm from pivoting relative to the base to hold the sleeve in a selected position relative to the base.

8. A mount assembly as set forth in claim 7, wherein the base is configured to selectively connect to a drive motor mounted on the boat for propelling the boat through water, thereby connecting the bracket to the boat via the base.

9. A mount assembly as set forth in claim 8, wherein the bracket is configured to be mounted on opposite sides of the drive motor by inverting the bracket.

10. A mount assembly as set forth in claim 1, further comprising a programmable control spaced from the housing and operatively connected to the control module in the hollow interior of the housing to signal the control module to rotate the output of the stepper motor.

11. A mount assembly as set forth in claim 10, wherein said programmable control is adapted to receive user input to signal the control module to rotate the output of the stepper motor to rotate the shaft clockwise as viewed from above relative to the bracket and to receive user input to signal the control module to rotate the output of the stepper motor to rotate the shaft counterclockwise as viewed from above relative to the bracket.

12. A mount assembly as set forth in claim 11, further comprising:
a left pedal input mechanism operatively connected to the programmable control for providing the user input to signal the control module to rotate the output of the stepper motor to rotate the shaft counterclockwise as viewed from above relative to the bracket; and
a right pedal input mechanism operatively connected to the programmable control for providing the user input to signal the control module to rotate the output of the stepper motor to rotate the shaft clockwise as viewed from above relative to the bracket.

13. A mount assembly as set forth in claim 11, wherein said programmable control is adapted to receive user input to signal the control module to reciprocatively rotate the output of the stepper motor to reciprocatively rotate the shaft through a predetermined angle to sweep the sonar transducer through a corresponding arc.

14. A mount assembly as set forth in claim 11, further comprising a cable extending between the programmable control and the control module to operatively connect the programmable control and the control module.

15. A mount assembly for connecting a sonar transducer to a boat for locating aquatic life in water adjacent to the boat, said mount assembly comprising:
a bracket capable of being connected to a boat, the bracket including a sleeve;
a housing having a hollow interior mounted on the bracket;
a stepper motor positioned inside the hollow interior of the housing, said stepper motor having an output that rotates relative to the housing in response to an input signal;
a control module operatively connected to the stepper motor, said control module being adapted to send the input signal to the stepper motor to selectively rotate the output;
an elongated shaft extending through the sleeve to mount the housing on the bracket, said shaft having an upper end, a lower end, and an elongated central axis extending between the upper end and the lower end, said upper end being operationally connected to the output of the stepper motor for selective rotation about the central axis relative to the housing when the control module sends the input signal to the stepper motor, said shaft being adapted to mount a sonar transducer adjacent to the lower end for positioning the sonar transducer in water;
an elastically deformable ferrule having an opening corresponding to the shaft; and
a fastener adapted to be selectively screwed to the sleeve to compress the ferrule to hold the shaft in the sleeve to prevent the shaft from moving longitudinally relative to the central axis in the sleeve, wherein the fastener is adapted to be selectively unscrewed from the sleeve to allow the ferrule to expand to release the shaft permitting the shaft to be moved longitudinally relative to the central axis of the sleeve.

16. A mount assembly as set forth in claim 15, wherein:
the sleeve extends between an upper end and a lower end opposite the upper end;
said ferrule is an upper ferrule;
said fastener is an upper fastener adapted to be selectively screwed to the upper end of the sleeve to compress the upper ferrule; and
the mount assembly further comprises:
a lower elastically deformable ferrule having an opening corresponding to the shaft; and
a lower fastener adapted to be selectively screwed to the lower end of the sleeve to compress the lower ferrule to hold the shaft in the sleeve; and
when the upper fastener and the lower fastener are screwed to the sleeve, the upper fastener compresses the upper ferrule, and the lower fastener compresses the lower ferrule to hold the shaft in the sleeve to prevent the shaft from moving in the sleeve; and
when the upper fastener and the lower fastener are unscrewed from the sleeve the upper fastener permits the upper ferrule to expand and the lower fastener permits the lower ferrule to expand to release the shaft permitting the shaft to be moved longitudinally relative to the central axis of the sleeve.

17. A mount assembly as set forth in claim 15, wherein the bracket includes:
a base adapted for connecting to the boat;
an arm pivotally connected to the base, said sleeve extending from the arm so that the sleeve moves relative to the base as the arm pivots with respect to the base; and
a clamp capable of preventing the arm from pivoting relative to the base to hold the sleeve in a selected position relative to the base.

18. A mount assembly as set forth in claim 15, further comprising a programmable control spaced from the housing and operatively connected to the control module in the hollow interior of the housing to signal the control module to rotate the output of the stepper motor, wherein said programmable control is adapted to receive user input to signal the control module to rotate the output of the stepper motor to rotate the shaft clockwise as viewed from above relative to the bracket and to receive user input to signal the control module to rotate the output of the stepper motor to rotate the shaft counterclockwise as viewed from above relative to the bracket.

19. A mount assembly for connecting a sonar transducer to a boat for locating aquatic life in water adjacent to the boat, said mount assembly comprising:
a bracket including:
a base adapted for connecting to the boat;
an arm pivotally connected to the base; and
a clamp capable of preventing the arm from pivoting relative to the base;
a housing having a hollow interior mounted on the arm of the bracket so that the housing moves relative to the base as the arm pivots with respect to the base;
a stepper motor positioned inside the hollow interior of the housing, said stepper motor having an output that rotates relative to the housing in response to an input signal;
a control module operatively connected to the stepper motor, said control module being adapted to send the input signal to the stepper motor to selectively rotate the output;
an elongated shaft extending through the sleeve to mount the housing on the bracket, said shaft having an upper end, a lower end, and an elongated central axis extending between the upper end and the lower end, said upper end being operationally connected to the output of the stepper motor for selective rotation about the central axis relative to the housing when the control module sends the input signal to the stepper motor, said shaft being adapted to mount a sonar transducer adjacent to the lower end for positioning the sonar transducer in water; and
a programmable control spaced from the housing and operatively connected to the control module in the hollow interior of the housing to signal the control module to rotate the output of the stepper motor, wherein said programmable control is adapted to receive user input to signal the control module to rotate the output of the stepper motor to rotate the shaft clockwise as viewed from above relative to the bracket and to receive user input to signal the control module to rotate the output of the stepper motor to rotate the shaft counterclockwise as viewed from above relative to the bracket.

20. A mount assembly as set forth in claim 19, wherein:
the arm of the bracket includes a sleeve;
the elongated shaft extends through the sleeve to mount the housing on the arm; and
the mount assembly further comprises:
an elastically deformable ferrule having an opening corresponding to the shaft; and
a fastener adapted to be selectively screwed to the sleeve to compress the ferrule to hold the shaft in the sleeve to prevent the shaft from moving longitudinally relative to the central axis in the sleeve, wherein the fastener is adapted to be selectively unscrewed from the sleeve to allow the ferrule to expand to release the shaft permitting the shaft to be moved longitudinally relative to the central axis of the sleeve.
